(19) United States
(12) Patent Application Publication
(10) Pub. No.: US 2022/0225580 A1
(43) Pub. Date: Jul. 21, 2022

(54) GARDEN PLANT SUPPORT APPARATUS AND METHOD OF USE THEREOF

(71) Applicant: Igor Magidov, Millstone, NJ (US)

(72) Inventor: Igor Magidov, Millstone, NJ (US)

(21) Appl. No.: 17/574,910

(22) Filed: Jan. 13, 2022

Related U.S. Application Data
(60) Provisional application No. 63/139,986, filed on Jan. 21, 2021.

(51) Int. Cl. A01G 9/12

(52) U.S. Cl. CPC A01G 9/124

(57) ABSTRACT

A plant stand configured to be placed within a plant container is provided, the plant stand includes: a base having a top surface and a bottom surface opposite the top surface, the top surface having a plurality of apertures extending at least partially into the base, the apertures having a shape and dimensions; one or more poles having an end, the end of the one or more poles shaped and dimensioned to be removably coupled to the base via the apertures such that the one or more poles extends from the top surface of the base essentially vertically; and a plurality of supports extending outward from the bottom surface of the base and having a height sufficient to create a clearance between a surface within the plant container on which the base is placed and the bottom surface of the base.

The present application claims priority to U.S. Provisional Application No. 63/139,986, filed Jan. 21, 2021, entitled “Garden Plant Support Apparatus and Method of Use Thereof” which is hereby incorporated herein by reference.

### BACKGROUND

The present application relates to gardening accessories and more particularly tools for use in starting or transplanting plants in containers.

Plant containers come in various sizes and typically include holes in the bottom that drip excess water into a shallow drip pan. Gardeners fill the container with soil, followed by inserting the desired transplant into the soil filled container. Thereafter, the gardener will water the plant periodically as necessary. Once the plant has taken root, the gardener may insert a post to support the plant as it grows. These systems, however, present several problems. First, overwatering will cause the water to spill over the shallow drip pan. Additionally, if there is water in the pan, moving the plant/container may cause the water to spill. Finally, inserting the post into the soil may damage the plant roots. Accordingly, there is a need for a planting system that is not so limited.

### 1. SUMMARY OF THE INVENTION

In one aspect, a plant stand configured to be placed within a plant container is provided, the plant stand includes: a base having a top surface and a bottom surface opposite the top surface, the top surface having a plurality of apertures extending at least partially into the base, the apertures having a shape and dimensions; one or more poles having an end, the end of the one or more poles shaped and dimensioned to be removably coupled to the base via the apertures such that the one or more poles extends from the top surface of the base essentially vertically; and a plurality of supports extending outward from the bottom surface of the base and having a height sufficient to create a clearance between a surface within the plant container on which the base is placed and the bottom surface of the base.

In one embodiment, the top surface is planar and wherein the top surface remains essentially horizontal when placed in the plant container.

In one embodiment, the apertures extend through the base and allow water to drain into a chamber within the plant container created by the clearance between the surface within the plant container on which the base is placed and the bottom surface of the base.

In one embodiment, the base is made from a porous material that allows water to pass through the base and into a chamber within the plant container created by the clearance between the surface within the plant container on which the base is placed and the bottom surface of the base.

In one embodiment, the height of the supports is from about 0.5″ to about 6″.

In one embodiment, the base has a circular profile and wherein a diameter of the base is from about 5½″ to about 13½″.

In another aspect, a method is provided for placing a plant stand within a plant container, the plant stand having a base with a top surface and a bottom surface opposite the top surface, the top surface having a plurality of apertures extending at least partially into the base, the apertures having a shape and dimensions; one or more poles having an end, the end of the one or more poles shaped and dimensioned to be removably coupled to the base via the apertures such that the one or more poles extends from the top surface of the base essentially vertically, and a plurality of supports extending outward from the bottom surface of the base and having a height sufficient to create a clearance between a surface within the plant container on which the base is placed and the bottom surface of the base, the method includes: providing a plant container having an opening therein; placing the plant stand into the opening of the plant container with the plurality of supports touching the surface within the plant container; installing the at least one poles in at least one of the apertures; placing a first volume of soil into the opening of the plant container over the base; adding a plant over the first volume of soil; and covering a root ball of the plant with a second volume of soil.

In one embodiment, the plant container is provided without draining holes.

In one embodiment, the top surface is planar and wherein the top surface remains essentially horizontal when placed in the plant container.

In one embodiment, the apertures extend through the base and allow water to drain into a chamber within the plant container created by the clearance between the surface within the plant container on which the base is placed and the bottom surface of the base.

In one embodiment, the base is made from a porous material that allows water to pass through the base and into a chamber within the plant container created by the clearance between the surface within the plant container on which the base is placed and the bottom surface of the base.

In one embodiment, the height of the supports is from about 0.5″ to about 6″.

In one embodiment, the base has a circular profile and wherein a diameter of the base is from about 5½″ to about 13½″.

In one embodiment, a chamber within the plant container is created by the clearance between the surface within the plant container on which the base is placed and the bottom surface of the base and the chamber remains essentially free of the soil.

In one embodiment, the method includes attaching the one or more poles to the plant.

In one embodiment, the one or more poles has therein at least one aperture, the method comprising attaching the one or more poles to the plant via the at least one aperture in the one or more poles.

Additional aspects of the present invention will be apparent in view of the description which follows.

### BRIEF DESCRIPTION OF THE FIGURES

FIGS. 1-7 depict views of plant stands according to at least one embodiment of the stands disclosed herein.

### DETAILED DESCRIPTION OF THE INVENTION

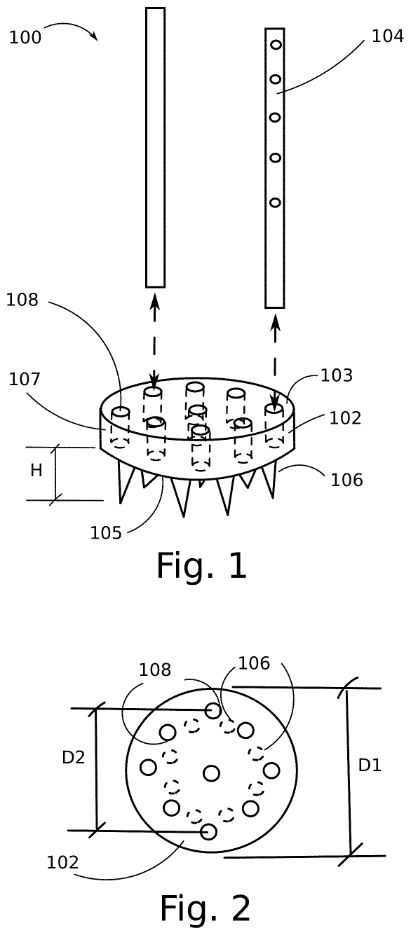

A present application is directed at a novel garden plant stand 100, as shown in FIGS. 1-2, for use within the plant container, as described below, which includes a base 102 and one or more poles 104, removably connected to the base 102 such that, when in use as directed, the base 102 is positioned essentially horizontal, i.e., parallel to the surface on which the base is placed, while one or more poles 104 is positioned essentially vertical, i.e., perpendicular to a top surface of the base 102.

As shown on the attached drawings, the base 102 includes a top surface 103, a bottom surface 105, and a side surface 107, where the top surface 103 has essentially flat planar configuration and includes a plurality of apertures 108 protruding into at least partially or preferably through the bottom surface 105 of the base 102. The bottom surface 105 of the base is equipped with a plurality of stand-supports 106 ensuring stable positioning of the base 102 on a flat surface and having a height sufficient to create a clearance between the surface on which the base 102 is placed and the bottom surface 105 of the base 102. A configuration of the base may be of any shape, e.g., round, oval, triangular, rectangular, pentagonal, hexagonal, octagonal configuration or the like, to fit within a gardening pot or container (terms used interchangeably herein) in which the disclosed garden plant stand apparatus 100 is installed, as discussed below. The shape of the supports 106 may similarly be any shape.

In one embodiment, each of the plurality of apertures 108 may be of round, oval, triangular, rectangular, pentagonal, hexagonal, octagonal configuration or the like. A plurality of apertures 108 enables removable attachment of one or more poles 104 to any area of the top surface of the base. Preferably, the end of the pole 104 is sized to create a friction or interference fit between two mating parts which hold together by friction after the parts are pushed together.

Each of one or more poles 104 has an elongated structure with a first terminal end and a second terminal end. At least one of the first terminal end or the second terminal end has a configuration matching a configuration of each of the plurality of the apertures 108 of the base 102 to ensure a secure removable connection to the base. That is, the apertures 108 may all have the same shape and dimensions, so that the apertures 108 are configured to receive a similarly shaped terminal end of the poles 104.

In one other embodiment, the top surface 103 of the base 102 and the bottom surface 105 of the base 102 are made of a porous material to replace the need in having a plurality of apertures and enabling one or more poles 104 to be simply inserted in the base 102 through the base's porous structure at any portion of the base's top surface 103 while providing a secure removable connection of one of more poles to the base.

In one other embodiment, when the garden plant stand apparatus 100 is in use as directed, the base 102 is positioned essentially horizontal, i.e., parallel to the surface on which the base is placed, while one or more poles 104 is positioned at some angle, not necessarily perpendicular, relative to the base 102.

The apparatus 100 may be sized to fit common container dimensions. Table A below provides dimensions for common containers along with preferred dimensions for the apparatus 100: D1 (outside diameter of the apparatus), D2 (centerline distance between opposing apertures 108), and H (height of the supports 106). The pot 300 and base 102 may be shaped and sized so that the base 102 fits within the pot 300 with a nominal clearance, e.g., ⅛″-¼″, between the side wall 107 of the base and sides of the pot 300 at least around the top surface 103. This nominal clearance allows water to drain while substantially preventing soil from entering the chamber created by the supports. A gasket may be provided that extends outward of the side surface 107 and that forms a seal between the apparatus and the container to prevent soil from working its way into the chamber created with the supports. Alternatively or additionally, a porous material dimensioned greater than the area of the top surface 103 may be installed over the apparatus to prevent soil from entering into the chamber, while allowing water to pass through the material, the apertures, and into the chamber.

TABLE A
38.

| 2. | 3. | | 4. | | 5. | | 6. | | 7. | |
|---|---|---|---|---|---|---|---|---|---|---|
| Size | Diameter | | Height | | D1 | | D2 | | H | |
| 8. #1 | 9. | 6 ½″ | 10. | 7″ | 11. | 5 ½-6″ | 12. | 4″-5″ | 13. | 0.5″-2.5″ |
| container | | | | | | | | | | |
| 14. #2 | 15. | 8 ¾″ | 16. | 8 ½″ | 17. | 7 ¾″-8 ¼″ | 18. | 4″-6″ | 19. | 0.5″-3.5″ |
| container | | | | | | | | | | |
| 20. #3 | 21. | 11″ | 22. | 9 ⅝″ | 23. | 10″-10 ½″ | 24. | 4″-7″ | 25. | 0.5″-4.5″ |
| container | | | | | | | | | | |
| 26. #5 | 27. | 10 ¾″ | 28. | 11″ | 29. | 9 ¾″-10 ¼″ | 30. | 4″-8″ | 31. | 0.5″-5.5″ |
| container | | | | | | | | | | |
| 32. #7 | 33. | 14″ | 34. | 11 ½″ | 35. | 13″-13 ½″ | 36. | 4″-12″ | 37. | 0.5″-6″ |
| container | | | | | | | | | | |

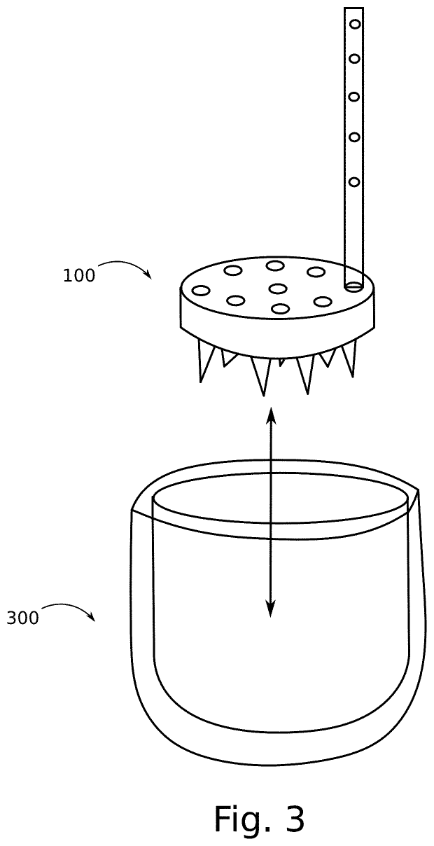

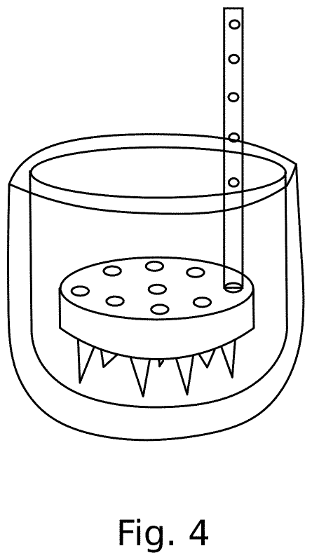

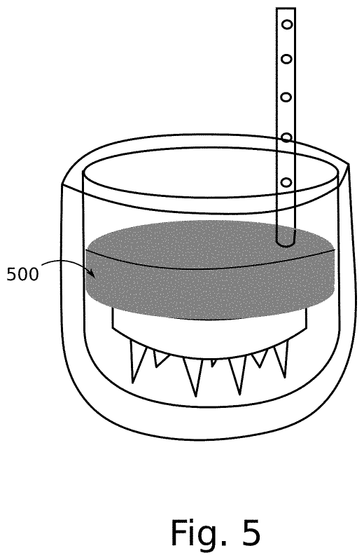

The method of operation of the disclosure of the garden plant stand apparatus 100, as illustrated in FIGS. 3-7, is as follows. The base 102 of the apparatus 100 (with or without the pole(s) 104) is placed inside a gardening pot 300 in which a plant is intended to be placed. The pot 300 may be one without drainage holes at the bottom, therewith allowing the user of the apparatus 100 to use any container even though not specifically designed for potting plants, without the fear of overwatering. The stand-supports 106 located on the bottom surface of the base 102 ensure creation of a clearance between the bottom of the gardening pot 300 and the bottom surface 105 of the base 102 for sufficient space for aeration and permeation of the soil to nourish the plant positioned inside the gardening pot 300. Once the base 102 is placed inside the gardening pot 300, one or more poles 104 is attached to the base 102 at a portion of the base 102 to ensure a plant's stable positioning within the gardening pot. Once the base 102 with the attached one or more poles 104 is placed inside the gardening pot 300, as shown in FIG. 4, a requisite amount of soil 500 is placed inside the gardening pot 300 such that the base 102 of the disclosed garden plant stand apparatus 100 is fully covered by soil 500 while the clearance between the bottom of the gardening pot 300 and the bottom surface 105 of the base 102 remains essentially free of the soil for the purposes of containing some amount of soil, an air and water, as shown in FIG. 5. A requisite amount of soil 500 in the gardening pot 300 ensures that the base 102 of the garden plant stand apparatus 100 is placed securely inside the gardening pot and will not pivot or tip over under the weight of the plant planted in the soil within the gardening pot and attached to the one or more poles.

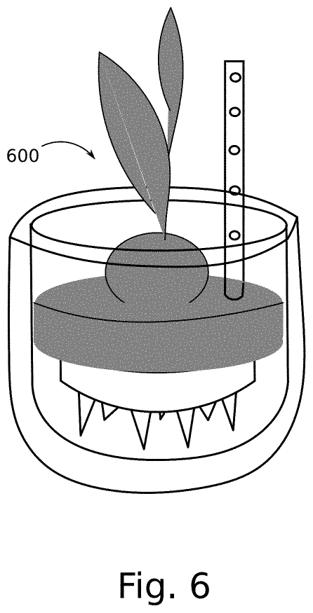

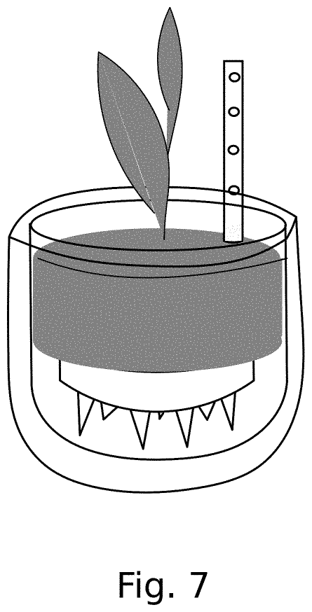

Once a requisite amount of soil 500 is placed inside the gardening pot 300 and only the one or more poles 104 remain above the soil in the gardening pot 300, a plant 600 is added inside the gardening pot 300 in the soil and attached to the one or more poles 104 for an upright support and prevention of tipping over, as shown in FIG. 6. The pole(s) 104 may include a plurality of holes therein for threading twine therethrough and around the stem of the plant for supporting the plant 600. Finally, the root ball of the plant 600 may be covered with additional soil, as shown in FIG. 7, to complete the transplant into the container.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A plant stand configured to be placed within a plant container, the plant stand comprising:
a base having a top surface and a bottom surface opposite the top surface, the top surface having a plurality of apertures extending at least partially into the base, the apertures having a shape and dimensions;
one or more poles having an end, the end of the one or more poles shaped and dimensioned to be removably coupled to the base via the apertures such that the one or more poles extends from the top surface of the base essentially vertically; and
a plurality of supports extending outward from the bottom surface of the base and having a height sufficient to create a clearance between a surface within the plant container on which the base is placed and the bottom surface of the base.

2. The plant stand of claim 1, wherein the top surface is planar and wherein the top surface remains essentially horizontal when placed in the plant container.

3. The plant stand of claim 1, wherein the apertures extend through the base and allow water to drain into a chamber within the plant container created by the clearance between the surface within the plant container on which the base is placed and the bottom surface of the base.

4. The plant stand of claim 1, wherein the base is made from a porous material that allows water to pass through the base and into a chamber within the plant container created by the clearance between the surface within the plant container on which the base is placed and the bottom surface of the base.

5. The plant stand of claim 1, wherein the height of the supports is from about 0.5″ to about 6″.

6. The plant stand of claim 1, wherein the base has a circular profile and wherein the diameter of the base is from about 5½″ to about 13½″.

7. A method for placing a plant stand within a plant container, the plant stand having a base with a top surface and a bottom surface opposite the top surface, the top surface having a plurality of apertures extending at least partially into the base, the apertures having a shape and dimensions; one or more poles having an end, the end of the one or more poles shaped and dimensioned to be removably coupled to the base via the apertures such that the one or more poles extends from the top surface of the base essentially vertically, and a plurality of supports extending outward from the bottom surface of the base and having a height sufficient to create a clearance between a surface within the plant container on which the base is placed and the bottom surface of the base, the method comprising:
providing a plant container having an opening therein;
placing the plant stand into the opening of the plant container with the plurality of supports touching the surface within the plant container;
installing the at least one poles in at least one of the apertures;
placing a first volume of soil into the opening of the plant container over the base;
adding a plant over the first volume of soil; and
covering a root ball of the plant with a second volume of soil.

8. The method of claim 7, wherein the plant container is provided without draining holes.

9. The method of claim 7, wherein the top surface is planar and wherein the top surface remains essentially horizontal when placed in the plant container.

10. The method of claim 7, wherein the apertures extend through the base and allow water to drain into a chamber within the plant container created by the clearance between the surface within the plant container on which the base is placed and the bottom surface of the base.

11. The method of claim 7, wherein the base is made from a porous material that allows water to pass through the base and into a chamber within the plant container created by the clearance between the surface within the plant container on which the base is placed and the bottom surface of the base.

12. The method of claim 7, wherein the height of the supports is from about 0.5″ to about 6″.

13. The method of claim 7, wherein the base has a circular profile and wherein the diameter of the base is from about 5½″ to about 13½″.

14. The method of claim 7, wherein a chamber within the plant container is created by the clearance between the surface within the plant container on which the base is placed and the bottom surface of the base and the chamber remains essentially free of the soil.

15. The method of claim 7, comprising attaching the one or more poles to the plant.

16. The method of claim 7, wherein the one or more poles has therein at least one aperture, the method comprising attaching the one or more poles to the plant via the at least one aperture in the one or more poles.
